(19) United States
(12) Patent Application Publication
(10) Pub. No.: US 2024/0264321 A1
(43) Pub. Date: Aug. 8, 2024

(54) Seismic Arrival-Time Picking on Distributed Acoustic Sensing (DAS) Using Semi-Supervised Learning

(71) Applicant: California Institute of Technology, Pasadena, CA (US)

(72) Inventors: Weiqiang Zhu, Berkeley, CA (US); Zhongwen Zhan, Arcadia, CA (US); Zachary E. Ross, Studio City, CA (US)

(73) Assignee: California Institute of Technology, Pasadena, CA (US)

(21) Appl. No.: 18/435,876

(22) Filed: Feb. 7, 2024

Related U.S. Application Data
(60) Provisional application No. 63/444,031, filed on Feb. 8, 2023.

(51) Int. Cl. G01V 1/28

(52) U.S. Cl. CPC G01V 1/282; G01V 2210/30; G01V 2210/41

(57) ABSTRACT

A computer-implemented method and system provide the ability to detect an earthquake. Distributed acoustic sensing (DAS) data is obtained. A deep neural network model that picks seismic phase arrival times on the DAS data is acquired. A semi-supervised learning approach is utilized to train the deep neural network model. The semi-supervised learning approach utilizes existing labels from a defined seismic dataset to generate pseudo labels on the DAS data. An earthquake is detected by applying the trained deep neural network model to new DAS data.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/444,031, filed on Feb. 8, 2023, with inventor(s) Weiqiang Zhu, Zhongwen Zhan, and Zachary E. Ross, entitled “Seismic Phase Arrival-Time Picking on Distributed Acoustic Sensing Data Using Semi-Supervised Learning,” attorneys' docket number 176.0226USP1.

### BACKGROUND OF THE INVENTION

### 1. Field of the Invention

The present invention relates generally to earthquake detection, and in particular, to a method, system, apparatus, and article of manufacture for utilizing semi-supervised learning to train a deep neural network model to determine seismic phase arrival times on distributed acoustic sensing (DAS) data.

### 2. Description of the Related Art

(Note: This application references a number of different publications as indicated throughout the specification by reference numbers enclosed in brackets, e.g., [x]. A list of these different publications ordered according to these reference numbers can be found below in the section entitled “References.” Each of these publications is incorporated by reference herein.)

Distributed acoustic sensing (DAS) is a rapidly developing technology that can turn a fiber-optic cable of up to one hundred kilometers into an ultra-dense array of seismic sensors spaced only a few meters apart. DAS uses an interrogator unit to send laser pulses into an optical fiber and measure the Rayleigh back-scattering from the internal natural flaws of the optical fiber. By measuring the tiny phase changes between repeated pulses, DAS can infer the longitudinal strain or strain rate over time along a fiber-optic cable [1],[2],[3]. Previous studies have demonstrated that DAS can effectively record seismic waves [4],[5],[6],[7],[8],[9]. Compared with traditional forms of seismic acquisition, DAS has several potential advantages in earthquake monitoring. It provides unprecedented channel spacing of meters compared with tens-of-kilometers spacing of seismic networks. DAS can also take advantage of dark fibers (i.e., unused strands of telecommunication fiber) at a potentially low cost. Furthermore, DAS is suitable for deployment and maintenance in challenging environments, such as boreholes, offshore locations, and glaciers. New DAS interrogator units are becoming capable of longer sensing ranges at a lower cost with the development of high-speed Internet infrastructure [1]. Thus, DAS is a promising technology for improved earthquake monitoring and is under active research. However, applying DAS to routine earthquake monitoring tasks remains challenging due to the lack of effective algorithms for detecting earthquakes and picking phase arrivals, coupled with the high data volume generated by thousands of channels. The ultra-high spatial resolution of fiber-optic sensing is a significant advantage compared to seismic networks but also presents a challenge for traditional data processing algorithms designed for single- or three-component seismometers. For example, the commonly used STA/LTA (short-term averaging over long-term averaging) method is ineffective for DAS because DAS recordings are much noisier than dedicated seismometer data due to factors such as cable-ground coupling and sensitivity to anthropogenic noise. STA/LTA operates on a single DAS trace and therefore does not effectively utilize the dense spatial sampling provided by DAS. Template matching is another effective earthquake detection method, particularly for detecting tiny earthquake signals [11],[12],[13],[14]. However, the requirement of existing templates and high computational demands limit its applicability for routine earthquake monitoring [15],[16].

Deep learning, especially deep neural networks, is currently the state-of-the-art machine learning algorithm for many tasks, such as image classification, object detection, speech recognition, machine translation, text/image generation, and medical image segmentation [17]. Deep learning is also widely used in earthquake detection [18],[19],[20],[21],[22],[23] for studying dense earthquake sequences [24],[25],[26],[27],[28],[29] and routine monitoring seismicity [30],[31],[32],[33],[34]. Compared to the STA/LTA method, deep learning is more sensitive to weak signals of small earthquakes and more robust to noisy spikes that cause false positives for STA/LTA. Compared to the template matching method, deep learning generalizes similarity-based search without requiring precise seismic templates and is significantly faster. Neural network models automatically learn to extract common features of earthquake signals from large training datasets and are able to generalize to earthquakes outside the training samples. For example, the PHASENET model, which is a deep neural network model trained using earthquakes in Northern California, performs well when applied to tectonic [25],[26], induced [24],[27], and volcanic earthquakes [35],[36] in multiple places globally.

One critical factor in the success of deep learning in earthquake detection and phase picking is the availability of many phase arrival-time measurements manually labeled by human analysts over the past few decades. For example, Ross et al. [19] collected ˜1.5 million pairs of P and S picks from the Southern California Seismic Network; Zhu and Beroza employed ˜700k P and S picks from the Northern California Seismic Network; Michelini et al. built a benchmark dataset of ˜1.2 million seismic waveforms from the Italian National Seismic Network; Zhao et al. [38] formed a benchmark dataset of ˜2.3 million seismic waveforms from the China Earthquake Networks; Mousavi et al. created a global benchmark dataset (STEAD) of ˜1.2 million seismic waveforms; Several other benchmark datasets have also been developed for developing deep learning models [40],[41],[42]. Although many DAS datasets have been collected and more continue to be collected, most of these datasets have not yet been analyzed by human analysts. Manually labeling a large DAS dataset can be costly and time-consuming. As a result, there are limited applications of deep learning for DAS data. Most works focus on earthquake detection using a small dataset [44],[45],[46]. Accurately picking phase arrivals is an unsolved challenge for DAS data, hindering its applications to earthquake monitoring.

There have been a number of approaches proposed to train deep learning models with little or no manual labeling, such as data augmentation [47], simulating synthetic data [48],[49],[50], fine-tuning and transfer learning [51],[52], self-supervised learning [53], and unsupervised learning [54], [55]. However, those methods have not proven effective in picking phase arrival time on DAS data. One challenge is the difference in the mathematical structures between seismic data and DAS data, i.e., ultra-dense DAS arrays and sparse seismic networks, which makes it difficult to implement model fine-tuning or transfer learning. Additionally, phase arrival-time picking requires high temporal accuracy, which is difficult to achieve through self-supervised or unsupervised learning without accurate manual picks. Semi-supervised learning provides an alternative approach, which is designed for problems with limited labeled data and abundant unlabeled data [56],[57]. There are several ways to utilize a large amount of unlabeled data as weak supervision to improve model training. One example is the Noisy Student method [56], which consists of three main steps: 1) training a teacher model on labeled samples, 2) using the teacher to generate pseudo labels on unlabeled samples, and 3) training a student model on the combination of labeled and pseudo-labeled data. Thus, the Noisy Student method can leverage a substantial amount of unlabeled data to improve model accuracy and robustness.

### SUMMARY OF THE INVENTION

Embodiments of the invention include: (1) a deep neural network model that is designed to accurately pick seismic phase arrival times on distributed acoustic sensing (DAS) data, and (2) a semi-supervised learning approach to train the deep neural network model without manual labels of DAS data, but using pseudo labels generated by models designed for seismic data.

Embodiments of the invention provide the first deep learning model to address the seismic phase picking problem on DAS data. Two innovative ideas solve this problem: First, a semi-supervised learning method helps build a large pseudo-labeled dataset of DAS data. Building large datasets of manual labels is time-consuming and expensive, which blocks the application of machine learning and deep learning to DAS data. The semi-supervised learning approach of embodiments of the invention can use existing manual labels from conventional seismic datasets to generate pseudo labels on DAS data. Second, a deep neural network model for the 2D DAS data format is used to consider the spatial and temporal information of the DAS data. The neural network takes 2D DAS data as input, extracts features through a sequence of neural network layers, and maps to a 2D probability map of P-phase, S-phase, and noise. From the predicted 2D map, embodiments of the invention can detect and locate P and S phase arrivals.

Embodiments of the invention also demonstrate that the pseudo labels can be used to train an effective deep learning model (e.g., PHASENET-DAS) for picking seismic phases on DAS.

The picked seismic phase arrival times by PHASENET-DAS can be used to detect and locate earthquakes, invert source parameters, image subsurface velocity structures, etc. Therefore, embodiments of the invention significantly broaden the applications of DAS in earthquake monitoring. For example, embodiments of the invention can be used in earthquake monitoring, earthquake early warning, volcanic monitoring, fault zone imaging, ground motion and hazard assessment, etc. Embodiments of the invention can also be used in many industrial applications, such as, monitoring induced earthquakes for oil/gas production, wastewater injection, and carbon sequestration; tracking microearthquakes during borehole hydraulic fracturing; imaging and monitoring fluid movements, geotechnical changes, and leakage of oil/gas and CO2 reservoirs, etc.

### BRIEF DESCRIPTION OF THE DRAWINGS

Referring now to the drawings in which like reference numbers represent corresponding parts throughout:

FIG. 1 shows four examples of earthquake signals that can be observed in sections of the DAS array in accordance with one or more embodiments of the invention;

FIG. 2 illustrates SNR distributions of detected events across four DAS arrays in accordance with one or more embodiments of the invention;

FIG. 3 illustrates the residuals of differential arrival-times in accordance with one or more embodiments of the invention;

FIG. 4 illustrates magnitude and distance distributions of earthquakes in accordance with one or more embodiments of the invention;

FIG. 5 illustrates earthquake locations determined by phase arrival-times in accordance with one or more embodiments of the invention;

FIG. 6 illustrates the procedure of the semi-supervised learning approach in accordance with one or more embodiments of the invention;

FIG. 7 illustrates a neural network architecture in accordance with one or more embodiments of the invention;

FIG. 8 illustrates locations of an exemplary training dataset collected in Long Valley, C A and Ridgecrest, CA in accordance with one or more embodiments of the invention;

FIG. 9 illustrates the logical flow for detecting an earthquake in accordance with one or more embodiments of the invention;

FIG. 10 is an exemplary hardware and software environment used to implement one or more embodiments of the invention; and

FIG. 11 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

As described above, Distributed Acoustic Sensing (DAS) is an emerging technology for earthquake monitoring and sub-surface imaging. However, its distinct characteristics, such as unknown ground coupling and high noise level, pose challenges to signal processing. Existing machine learning models optimized for conventional seismic data struggle with DAS data due to its ultra-dense spatial sampling and limited manual labels. Embodiments of the invention introduce a semi-supervised learning approach to address the phase-picking task of DAS data. The pre-trained PHASENET model may be used to generate noisy labels of P/S arrivals in DAS data and the Gaussian mixture model phase association (GaMMA) method may be applied to refine these noisy labels and build training datasets. Embodiments of the invention may also utilize PHASENET-DAS, a deep learning model designed to process 2D spatial-temporal DAS data to achieve accurate phase picking and efficient earthquake detection. Studies demonstrate a method to develop/utilize deep learning models for DAS data, unlocking the potential of integrating DAS to improve earthquake monitoring.

In other words, embodiments of the invention provide a semi-supervised learning approach for training a deep learning model to pick seismic phase arrivals in DAS data without needing manual labels. Despite the differences in data modalities between DAS data (i.e., spatio-temporal) and seismic data (i.e., time series), the recorded seismic waveforms exhibit similar characteristics. Based on this connection, embodiments of the invention use semi-supervised learning to transfer the knowledge learned by PHASENET for picking P and S phase arrivals from seismic data to DAS data. A new neural network model, PHASENET-DAS, utilizes spatial and temporal information to consistently pick seismic phase arrivals across hundreds of DAS channels. Embodiments of the invention may utilize some concepts of pseudo labeling from [58] to generate pseudo labels of P and S arrival picks in DAS in order to train deep learning models using unlabeled DAS data.

Further, the semi-supervised learning method of embodiments of the invention is extended to bridge two data modalities of 1D seismic waveforms and 2D DAS recordings so that the advantages of the abundant manual labels of seismic data can be combined with the large volume of DAS data. Embodiments of the invention demonstrate the semi-supervised learning approach by training two models. The PHASENET-DAS V1 is trained using pseudo labels generated by PHASENET to transfer phase picking capability from seismic data to DAS. The PHASENET-DAS V2 is trained using pseudo labels generated by PHASENET-DAS V1 to further improve model performance similar to the Noisy Student method. In the evaluation described below, embodiments of the invention may default to using the PHASENET-DAS V2 model. Further to the above, the method of embodiments of the invention may be tested using DAS arrays in Long Valley and Ridgecrest, CA, and the performance of PHASENET-DAS may be evaluated in terms of number of phase picks, phase association rate, phase arrival time resolution, and earthquake detection and location.

### Results

### Phase Picking Performance

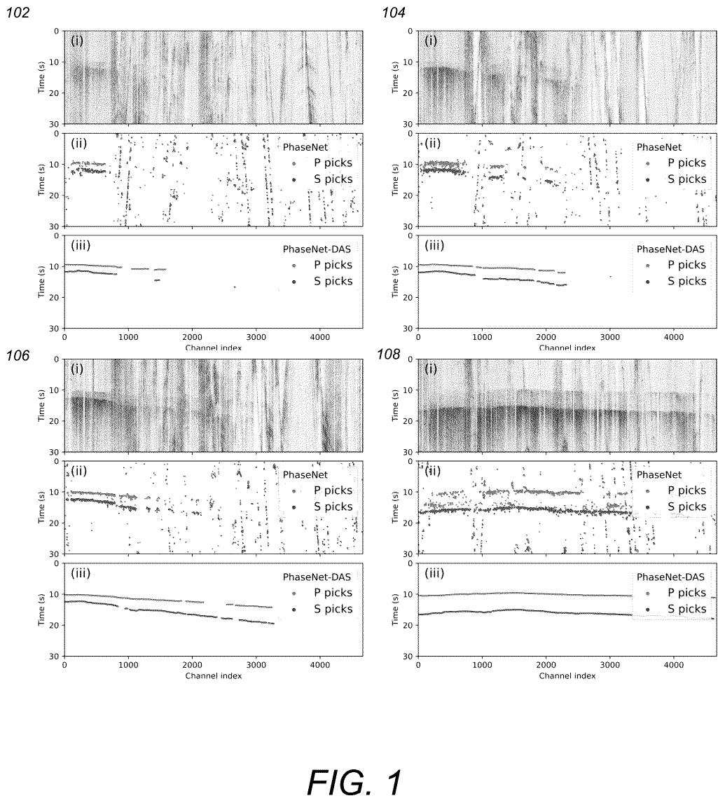

One challenge in picking phase arrivals in DAS data is the presence of strong background noise, as fiber-optic cables are often installed along roads or in urban environments, and DAS is highly sensitive to surface waves. The waveforms of traffic signals have certain resemblance to earthquake signals with sharp emergence of first arrivals and strong surface waves, which leads to many false detections by the pre-trained PHASENET model. Traffic signals are usually locally visible over short distances of a few kilometers without clear body waves. In contrast, earthquake signals tend to be much stronger and recorded by an entire DAS array with both body and surface waves present. Embodiments of the invention (e.g., including PHASENET-DAS) uses both spatial and temporal information across multiple channels of a DAS array, making it more robust to traffic noise. FIG. 1 shows four examples 102-108 of earthquake signals that can be observed in sections of the DAS array in accordance with one or more embodiments of the invention. Each panel shows (i) DAS recordings of 30s and 5000 channels; (ii) the PHASENET picks; and (iii) the PHASENET-DAS picks. Due to strong background noise, one can see that PHASENET detects many false P and S arrivals. However, PHASENET-DAS predictions have fewer false detections and are consistent across channels with reduced variation in the picked arrival times. Both models are applied to all events of four DAS cables and the number of associated picks are compared (since picks that can be successfully associated are more likely to be true positives). After applying the phase associator GaMMA 59, the rates of associated phase picks increase from 59%-69% for PHASENET to 89%-92% for PHASENET-DAS.

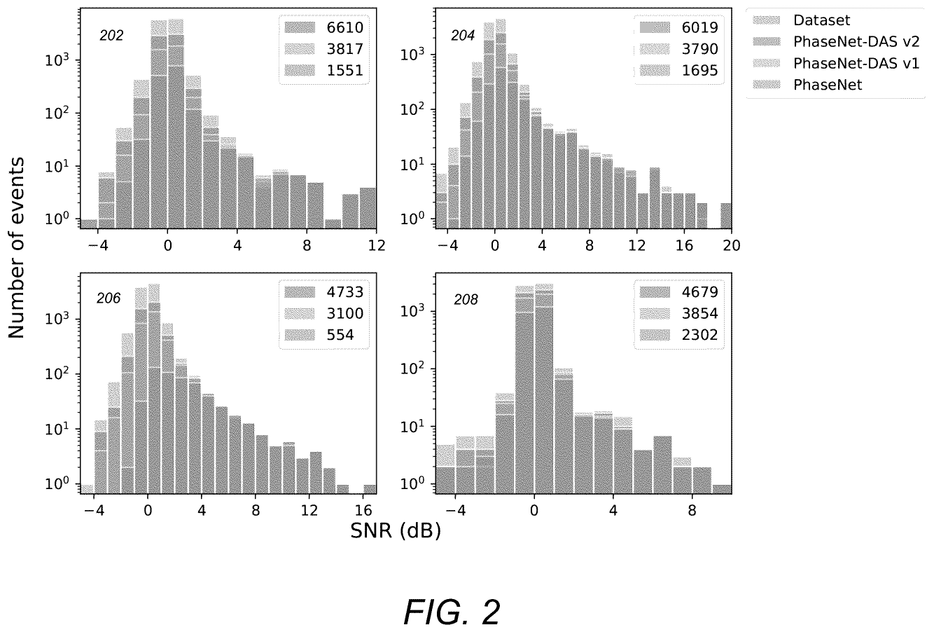

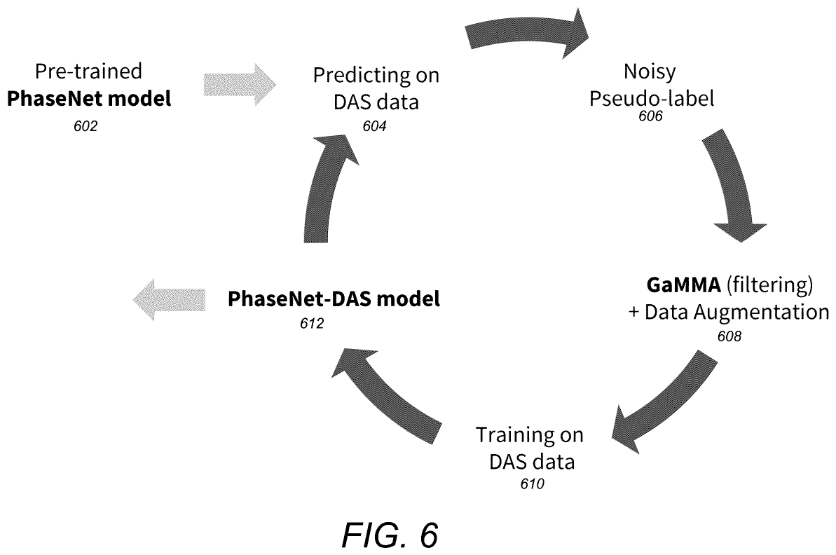

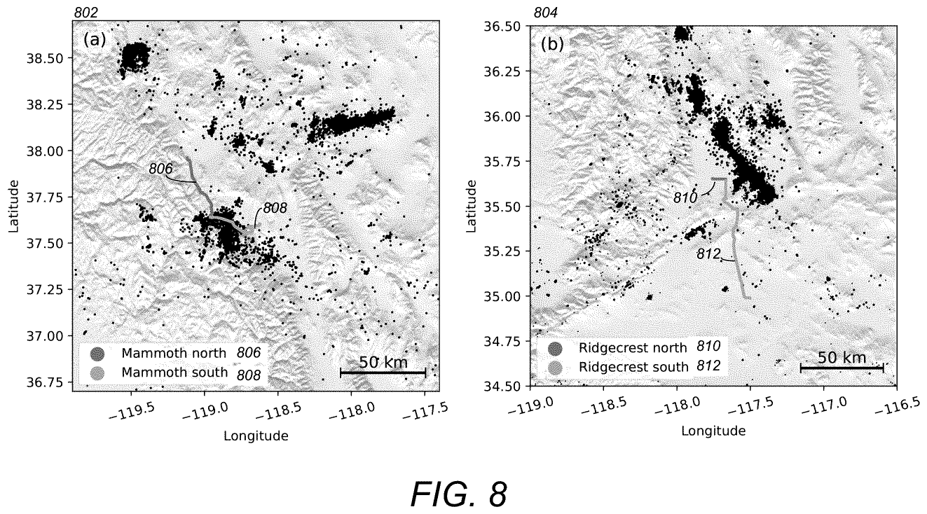

In addition to traffic noise, other factors such as poor ground coupling and instrumental noise make the signal-noise ratio (SNR) of DAS data generally lower than that of seismic data. The low SNR makes it challenging to detect and pick phase arrivals on DAS data. The PHASENET model pre-trained on seismic data can detect high SNR events, but struggles with low SNR events in DAS data (FIG. 2). In this regard, FIG. 2 illustrates SNR distributions of detected events across four DAS arrays in accordance with one or more embodiments of the invention. The four DAS arrays are Mammoth North 202, Mammoth South 204, Ridgecrest North 206, and Ridgecrest South 208. The locations of the four DAS arrays are shown in FIG. 8 (described in more detail below). The SNR is calculated using two 5-second windows before and after the theoretical IP wave arrival time. The PHASENET-DAS v1 and v2 models are from the first and second iterations of the semi-supervised learning procedures illustrated in FIG. 6 (described below).

After re-training using semi-supervised learning on DAS data, the PHASENET-DAS model significantly improves detections of low SNR events. PHASENET-DAS v1 detects 2-5 times more events than PHASENET across four DAS cables, and PHASENET-DAS v2 enhances detection sensitivity by an additional 25%-50% compared to PHASENET-DAS v1. Moreover, the number of phase picks per event also significantly increases for both high and low SNR events after re-training. This demonstrates that the PHASENET-DAS model, which is designed to use coherent spatial information, can effectively detect weaker earthquake signals recorded by DAS and pick P and S picks on more DAS channels than the PHASENET model, which is designed for 3-component seismic waveforms.

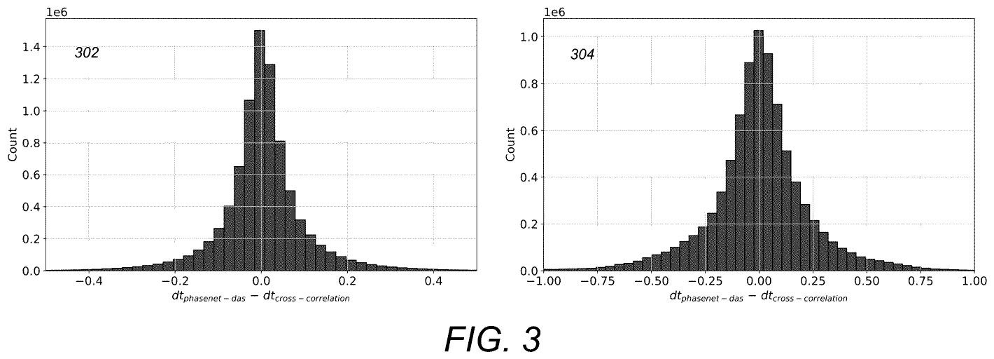

The noisy condition of DAS recording could also impact the temporal precision of picked phase arrival-times for both manual labeling and automatic algorithms. Because manual labels of P and S arrivals are lacking as benchmarks, one can evaluate the temporal accuracy of PHASENET-DAS's picks indirectly. FIG. 3 illustrates the residuals of differential arrival-times picked by PHASENET-DAS for P waves 302 and S waves 304 in accordance with one or more embodiments of the invention. Embodiments of the invention first measure differential arrival-times of PHASENET-DAS picks (dt_{phasenet-das}) and waveform cross-correlation (dt_{cross-correlation}) from selected event pairs. Then the residuals between these two differential arrival-times are calculated (dt_{phasenet-das}−dt_{cross-correlation}) to evaluate the accuracy of PHASENET-DAS picks, assuming waveform cross-correlation measurement as the ground truth.

In other words, embodiments of the invention first compared automatically picked phase arrival-times with the theoretical phase arrival-times using a 1D velocity model [60]. For events within ˜100 km, the automatic picks have small time residuals within 2 seconds, while the time residuals increase with epicenter distances. This discrepancy arises not from imprecise automatic picks, but from differences between the true 3D velocity model and the 1D velocity model we used. Then, embodiments of the invention conducted a more precise analysis of the automatically picked phase arrival-times by comparing the differential arrival times between two events measured using waveform cross-correlation. Waveform cross-correlation is commonly used for earthquake detection (known as template matching or match filtering) [11],[12],[13],[14], measuring differential travel-time [61],[62],[63],[64] and relative polarity [65],[66]. Cross-correlation achieves a high temporal resolution of the waveform sampling rate or super-resolution using interpolation techniques. A 4-s time window was cut around the arrival picked by PHASENET-DAS, a band-pass filter between 1 Hz to 10 Hz was applied, and the cross-correlation between event pairs was calculated. The differential time was determined from the peak of the cross-correlation profile.

Because DAS waveforms are usually much noisier than seismic waveforms and have low cross-correlation coefficients, the robustness of differential time measurements were improved using multi-channel cross-correlation [67],[68] to accurately extract the peaks across multiple cross-correlation profiles. 2,539 event pairs and ˜9 million differential time measurements for both P and S waves were selected as the reference to evaluate the temporal accuracy of PHASENET-DAS picks. FIG. 3 shows the statistics of these two differential time measurements. If one assumes the differential time measurements by waveform cross-correlation are the ground truth, the errors of differential time measurements by PHASENET-DAS have a mean of 0.001 s and a standard deviation of 0.06 s for P waves and a mean of 0.005 s and a standard deviation of 0.25 s for S waves. For comparison, the absolute arrival-time errors of the pre-trained PHASENET model, compared with manual picks, have a mean of 0.002 s and a standard deviation of 0.05 s for P waves and a mean of 0.003 s and a standard deviation of 0.08 s for S waves [20]. Although the differential time errors and absolute arrival-time errors cannot be directly compared, the similar scales of these errors demonstrate that one can effectively transfer the high picking accuracy of the pre-trained PHASENET model to DAS data.

### Applications to Earthquake Monitoring

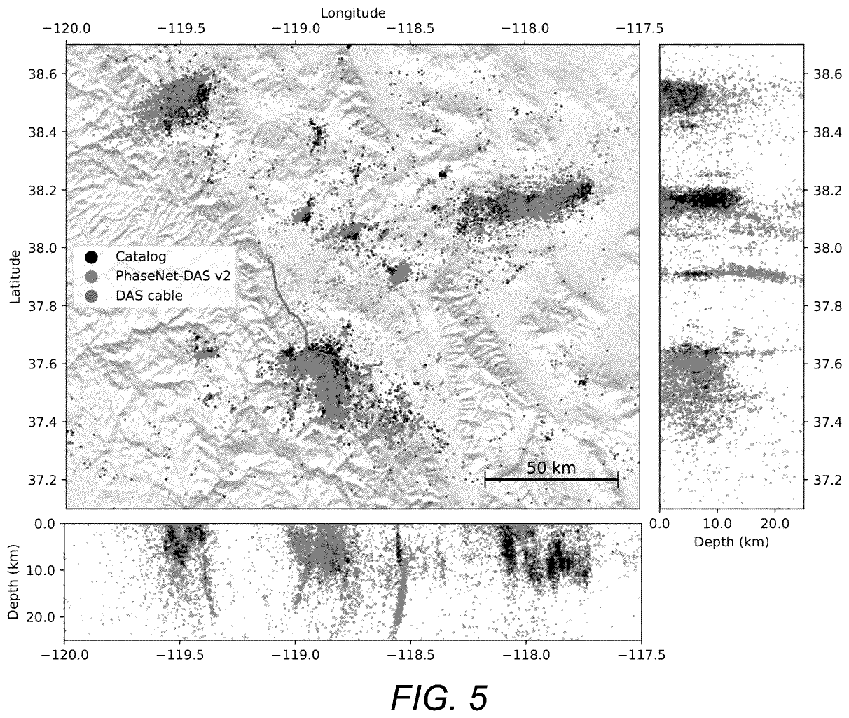

The experiments above demonstrate that PHASENET-DAS of embodiments of the invention can effectively detect and pick P- and S-phase arrivals with few false positives, high sensitivity, and precise temporal accuracy. These automatic phase arrival-time measurements can be applied to many seismic studies such as earthquake monitoring and seismic tomography. Here, embodiments of the invention further apply PHASENET-DAS to earthquake monitoring. Following a similar workflow of earthquake detection using seismic networks [69], embodiments of the invention applied PHASENET-DAS to DAS data of 11,241 earthquakes in the earthquake catalogs of Northern California Seismic Network, Southern California Seismic Network, and Nevada Seismic Network within 5 degrees from two Long Valley DAS arrays (see description of FIG. 5 below).

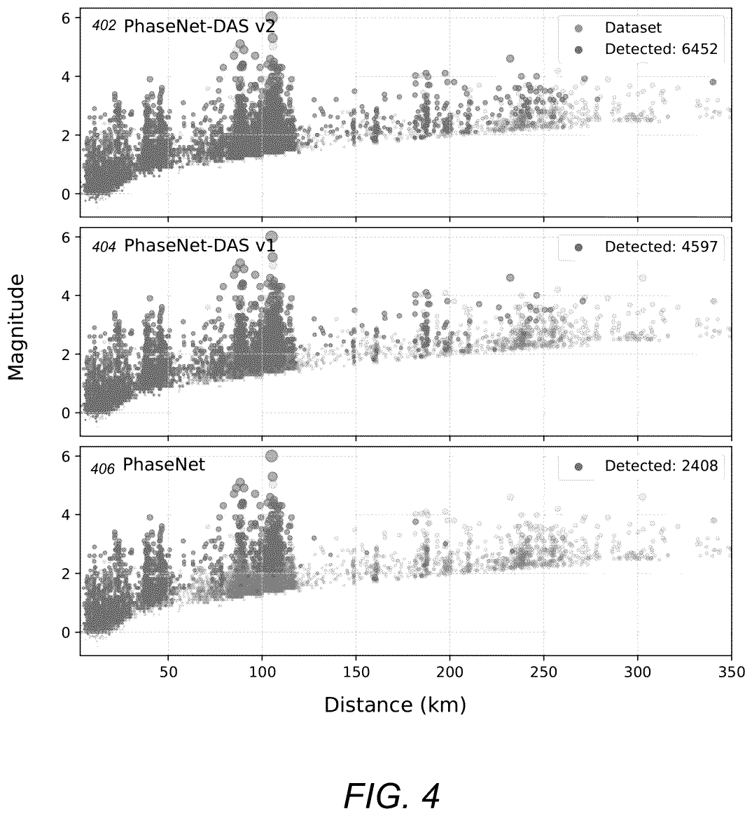

These events were filtered based on an approximate scaling relation determined by Yin et al. [70]. Because of different sensor coverages between seismic networks and DAS cables, seismic signals from distant but small magnitude events are expected to be too small to be detected by DAS, the absolute number of earthquakes in the standard catalogs and those detected by DAS cannot be directly compared. To evaluate the improvements from semi-supervised learning, the magnitude and distance distributions of earthquakes detected by three models, PHASENET, PHASENET-DAS v1, and PHASENET v2 were compared in FIG. 4.

FIG. 4 illustrates magnitude and distance distributions of earthquakes in accordance with one or more embodiments of the invention. More specifically, FIG. 4 illustrates distributions of earthquakes for PHASENET-DAS v2 402; PHASENET-DAS v1 404, and PHASENET 406. The gray dots are earthquakes in standard earthquake catalogs within 3 degrees of the Long Valley DAS array. The red dots indicate the earthquakes that can be detected with more than 500 associated P and S picks. The PHASENET-DAS v1 and v2 models are from the first and second iterations of semi-supervised learning (see description of FIG. 6 below). The histogram of earthquake numbers is shown in FIG. 3 (described above).

FIG. 5 illustrates earthquake locations determined by phase arrival-times measured by PHASENET-DAS in accordance with one or more embodiments of the invention. The black dots are earthquakes in the standard earthquake catalogs. The gray dots are earthquakes detected by the DAS arrays and the PHASENET-DAS v2 model. Only the DAS events corresponding to a catalog event are shown.

PHASENET-DAS significantly improves detection of both small magnitude events near the DAS array and large magnitude events at greater distances. Embodiments of the invention also plotted the approximate locations of these detected earthquakes determined by phase association (see FIG. 5 described below). The locations of events within the Long Valley caldera, which are close to the DAS array, can be well-constrained using these automatic arrival-time measurements, while the earthquake locations become less constrained with increasing epicentral distances due to the limited azimuthal coverage of a single DAS array. The physical limitation in azimuth and distance coverage could be addressed by combining seismic networks, deploying additional DAS arrays, or designing specific fiber geometries in future research.

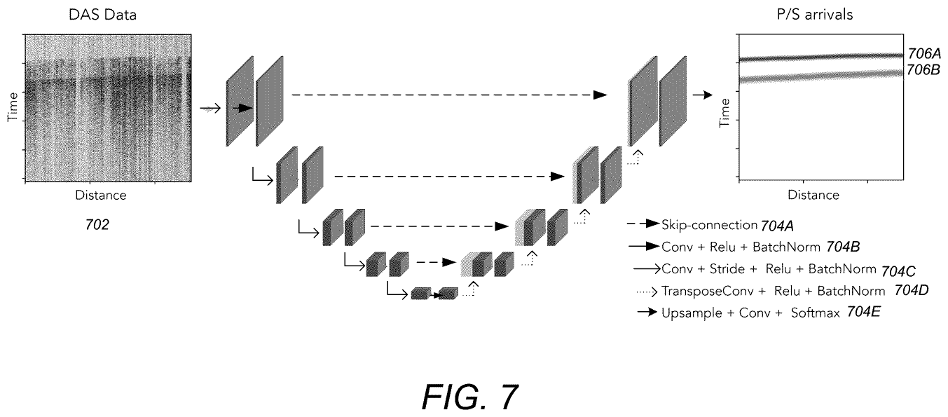

Lastly, embodiments of the invention evaluated PHASENET-DAS on continuous data to demonstrate its potential applications in large-scale data mining and real-time earthquake monitoring. PHASENET-DAS was applied to 180 hours of continuous data from 2020 Nov. 17 to 2020 Nov. 25 using a 5000-channel×200-s window sampled at 100 Hz without overlap. As PHASENET-DAS is a fully convolutional network (FIG. 7) and the convolution operator is independent of input data size, it can be directly applied to various time lengths and channel numbers subject to the memory limitations of computational servers. The picked phase arrivals were associated using GaMMA in the same manner as above. The results from these models show a good consistency, while PHASENET-DAS proves more effective in detecting several times more picks. The entire processing time of the continuous DAS data (180 hours and 10,000 channels, 1.8 million channel-hours) was ˜3.5 hours using 8 GPUs (NVIDIA TESLA V100). The model prediction of PHASENET-DAS is notably fast considering the substantial size of DAS data. Since the phase-picking task can be embarrassingly parallelized by segmenting DAS data into windows, the model prediction can be further accelerated with additional GPUs for large-scale data mining tasks. The rapid prediction speed of PHASENET-DAS also demonstrates its potential for real-time earthquake monitoring and earthquake early warning.

### Seismic Observation Analysis

DAS enhances seismic observations by turning the existing fiber optic infrastructure into dense arrays of sensors, recording seismic waveforms with unprecedented spatial resolutions. Meanwhile, deep learning advances seismic data processing by transforming historical datasets into effective models for analyzing earthquake signals. PHASENET-DAS (of embodiments of the invention) attempts to combine these advantages to effectively detect and pick seismic phase arrivals in DAS data. The semi-supervised learning approach bridges the gap between two distinct data modalities of 1D conventional seismic waveforms and 2D DAS recordings. This approach addresses the challenge of lack of manual labels in DAS data, facilitating an efficient transfer of phase-picking capability from pretrained deep learning models on 1D time series of seismic data to new models designed for 2D spatio-temporal measurement of DAS data. In addition to earthquake monitoring, the PHASENET-DAS model can be applied to other tasks such as seismic tomography and source characterization. In addition, the semi-supervised approach could also serve in developing/utilizing deep learning models for other seismic signals on DAS data, such as detecting tremors [71],[72] and picking first motion polarities [73] where large seismic archives are available.

Experiments demonstrate the improvements from semi-supervised learning. PHASENET-DAS, which is trained to pick phases across multiple channels of a DAS array, can effectively reduce false positive picks (FIG. 1), increase phase picks per event, detect more low SNR events (FIG. 2 and FIG. 4), and achieve a temporal precision similar to PHASENET (FIG. 3).

In addition to the above, potential limitations of the current model may also be considered. While the semi-supervised learning approach addresses the challenge of the lack of manual labels for DAS data, the pseudo labels generated by the pre-trained PHASENET model could potentially be subject to systematic bias, such as missing very weak first arrivals or confusing phase types using single-component data. In order to mitigate these biases, embodiments of the invention adopted two approaches. Firstly, phase association was applied to filter out inconsistent phase picks across channels. While the phase-picking step using PHASENET only considers information from a single channel, the phase association step incorporates physical constraints across multiple channels, i.e., the phase type should be the same for nearby channels, and the phase arrival time should follow the time move-out determined by channel locations and wave velocities. Through phase association, embodiments of the invention reduce the potential bias in pseudo labels of inaccurate phase time or incorrect phase types.

Secondly, strong data augmentation was added to the training dataset to increase its size and diversity. For example, various real noises were superposed on the training dataset in order to make the model more sensitive to weak phase arrivals. Because the pseudo labels are generated using data from high SNR events, sharp and clear first arrivals are less likely to be missed by PHASENET. By superposing strong noise, one can make these arrivals similar to the cases of low SNR data from either small magnitude earthquakes or strong background noise, such as during traffic hours. Through such data augmentation, we can reduce the potential bias in pseudo labels of missing weak arrivals for low SNR events. Other approaches, such as employing waveform similarity, could also be utilized to further reduce the bias in pseudo labels. Incorporating regularization techniques, such as adding Laplacian smoothing between nearby channels to the training loss, could be another direction to reduce the effect of inconsistent labels and improve model performance in future research.

Another common challenge for deep learning is model generalization to new datasets, as the performance of deep neural networks is closely tied to the training datasets. The current PHASENET-DAS model was trained and tested only using four DAS arrays in Long Valley and Ridgecrest, CA. The datasets are also formatted using a same temporal sampling of 100 Hz and a similar spatial sampling of ˜10 m. These factors may limit the model's generalization to DAS arrays at different locations and/or with varying spatial and temporal sampling rates. However, because manual labels of historical seismic data are readily available at many locations, one can also apply the semi-supervised learning approach to train deep learning models for other DAS arrays or fine-tune the pre-trained PHASENET-DAS models if limited DAS data is available.

In conclusion, with the deployment of more DAS instruments and the collection of massive DAS datasets, novel data processing techniques may be utilized to discover signals and gain insights from massive DAS data. Deep learning is widely applied in seismic data processing but has limited applications to DAS data due to the lack of manual labels for training deep neural networks. Embodiments of the invention provide a semi-supervised learning approach to pick P- and S-phase arrivals in DAS data without manual labels. The pre-trained PHASENET model was applied to generate noisy phase picks, the GaMMA model was used to associate consistent picks as pseudo labels, and a new deep neural network model, PHASENET-DAS, was trained and designed to utilize both the temporal and spatial information of DAS data. The experiments demonstrate that PHASENET-DAS can effectively detect P and S arrivals with fewer false picks, higher sensitivity to weak signals, and similar temporal precision compared to the pre-trained PHASENET model. PHASENET-DAS can be applied to earthquake monitoring, early warning, seismic tomography, and other seismic data analysis using DAS. The semi-supervised learning approach bridges the gap between limited DAS training labels and abundant historical seismic manual labels, facilitating future developments of deep learning models for DAS data.

### Components for Applying Deep Learning to Pick Phase Arrival Times in DAS Data

This section describes the three components for applying deep learning to accurately pick phase arrival times in DAS data: (1) the semi-supervised learning approach; (2) the PHASENET-DAS model; and (3) the training dataset.

### Semi-Supervised Learning

Embodiments of the invention provide a semi-supervised learning approach to train a deep-learning-based phase picker using unlabeled DAS data. The procedure of the semi-supervised learning approach is summarized in FIG. 6. More specifically, the PHASENET model 602 [20], which is pre-trained using a large dataset of seismic waveforms, is used to generate 604 pseudo-labels 606 on DAS data. Gamma filtering and data augmentation is performed at 608 to enable further training on the DAS data 610, resulting in the PHASE-NET DAS model 612. This semi-supervised approach transfers the phase picking capability from PHASENET 602 to the new PHASENET-DAS model 612 designed for DAS recordings.

In view of the above, embodiments of the invention first train a deep-learning-based phase picker (i.e., the PHASENET model 602) on three-component seismic waveforms using many analyst-labeled manual picks. Given the existence of several widely used deep-learning-based phase pickers [19],[20],[21], embodiments of the invention directly reuse the pre-trained PHASENET model 602 to omit retraining a deep-learning phase picker for conventional seismic data, which is not the focus of this invention. Despite PHASENET 602 being trained on three-component seismic waveforms, it can also be applied to single-component waveforms because channel dropout (i.e., randomly zero-out one or two channels) may be added as data augmentation [74].

Second, embodiments of the invention apply (via predicting 604) the pre-trained PHASENET model 602 to pick P and S arrivals on each channel of a DAS array independently to generate noisy pseudo labels 606 of P and S picks. While PHASENET works well on channels with high signal-to-noise (SNR) ratios in DAS data, its accuracy is limited compared to that in seismic data (FIG. 1). For example, the model could detect many false picks due to strong anthropogenic noise in DAS data. The picked phase arrival times also have large variations between nearby channels, since each channel is processed individually.

Third, embodiments of the invention apply the phase association method, Gaussian Mixture Model Associator (GaMMA) 608 [59] to filter out false picks and build a DAS training dataset with pseudo labels. GaMMA 608 selects only picks that fall within a narrow window of the theoretical arrival times corresponding to the associated earthquake locations. Embodiments of the invention may also set the time window size to 1 second in this study. This hyperparameter can be adjusted to balance the trade-off between the quantity and quality of pseudo labels. A small window size results in a small training dataset with high-quality pseudo labels. Conversely, a large window size creates a large training dataset with potentially less accurate arrival times.

Last, embodiments of the invention train 610 a new deep-learning-based phase picker designed for DAS data (i.e., the resulting model is illustrated in FIG. 6 as PHASENET-DAS Model 612). The model architecture is explained below with respect to FIG. 7. The training labels may utilize the same Gaussian-shaped target function as proposed by Zhu and Beroza [20]:

$${P}_{P} = {e}^{- \frac{{( t - t P )}^{2}}{2 {σ}^{2}}}$$

$${P}_{P} = {e}^{- \frac{{( t - {t}_{S} )}^{2}}{2 {σ}^{2}}}$$

$${P}_{N} = max ( 0 , 1 - {P}_{P} - {P}_{S} )$$

where t_{P} and t_{S} are arrival-times of P and S phase; P_{P}, P_{S}, and P_{N} are target functions for P-phase, S-phase, and Noise; and σ is a width of the Gaussian-shaped target function which is used to account for uncertainties in phase arrival times similar to label smoothing commonly used in computer vision 75. Embodiments of the invention may set σ to 1.5 seconds in this work. Because the pseudo labels are mostly picked on high SNR channels, a deep learning picker trained only on high SNR waveforms could generalize poorly to noisy waveforms. Data augmentation 608, such as superposing noise onto seismic events, can synthesize new training samples with noisy waveforms, significantly expand the training dataset, and improve model generalization on noisy DAS data and weak earthquake signals [47],[76]. In addition to superposing noise, embodiments of the invention may add augmentations of randomly flipping data along the spatial axis, masking part of data, superimposing double events, and stretching (resampling) along the temporal and spatial axes.

By following these steps, one can automatically generate a large dataset of high-quality pseudo labels and train a deep neural network model on DAS data. This newly trained model can be used to generate pseudo labels and train an improved model. This procedure can be repeated several times to enhance performance. Embodiments of the invention conducted two iterations using pseudo labels generated by PHASENET and PHASENET-DAS (with the two resulting models named PHASENET-DAS v1 and v2 for clarity).

### Neural Network Model

The pre-trained PHASENET model 602 may be based on U-Net architecture with 1D convolutional layers for processing 1D time series of seismic waveforms. DAS data, on the other hand, are 2D recordings of seismic wavefields with both spatial and temporal information. Accordingly, the pre-trained PHASENET model 602 cannot utilize the spatial information from DAS's ultra-dense channels. In order to exploit both spatial and temporal information of 2D DAS data, embodiments of the invention extend the PHASENET model 602 using 2D convolutional layers.

FIG. 7 illustrates the neural network architecture of PHASENET-DAS in accordance with one or more embodiments of the invention. The U-Net [77] architecture may be used to consider spatial and temporal information of 2D DAS recordings 702. PHASENET-DAS processes raw DAS data 702 through four stages (that include processing steps 704A-704E) of down-sampling and up-sampling and a sequence of 2D convolutional layers and ReLU (Rectified linear unit) activation functions and predicts P 706A and S 706B phase arrivals in each channel of the DAS array. More specifically, in order to consider the high spatial and temporal resolution of DAS data, embodiments of the invention use a larger convolutional kernel size (7×7) and a stride step (4×4) to increase the receptive field of PHASENET-DAS [78]. Further, embodiments of the invention add the transposed convolutional layers for up-sampling [79], batch normalization layers [80], ReLU activation functions [81], and skip connections to the model.

As illustrated, the processing steps 704A-704E include skipping a connection 704A, convolution+ReLU+BachNorm processing 704B, convolution+stride+ReLU+BatchNorm 704C, a transpose convolution+ReLU+BatchNorm 704D, and upsample+convolution+softmax 704E.

The semi-supervised approach does not require using the same neural network architecture as the pre-trained model, so that embodiments of the invention can also use other advanced architectures designed for the semantic segmentation task, such as DEEPLAB [82], deformable CONVNETS [83], and SWIN TRANSFORMER [84]. Further, embodiments of the invention may provide the ability to transfer the knowledge of seismic phase picking from seismic data to DAS data, and as such, may keep a simple U-Net architecture as PHASENET. In addition, optimal neural network architectures may be utilized (e.g., transformer [23],[84],[85]) for DAS data.

### Training Data

Referring to FIG. 8, embodiments of the invention collected a large training dataset using four DAS cables in Long Valley, CA 802 and Ridgecrest, CA 804. The lines 806-812 are the locations of the fiber-optic cables. The black dots are earthquakes in the standard earthquake catalogs used to build the training dataset. The Long Valley 802 DAS array consists of two cables, each with a length of 50 km, 5,000 channels, and a channel spacing of ˜10 m 8,86,87,88,89, referred to as the Mammoth north 806 and Mammoth south 808 cables for clarity. The Ridgecrest 804 DAS array consists of one short cable (10 km and 1,250 channels) and one long cable (100 km and 10,000 channels), referred to as the Ridgecrest north 810 and Ridgecrest south 812 cables respectively. The cable locations are determined using a GPS-tracked moving vehicle (e.g., the vehicle developed by Biondi et al. [89]). Embodiments of the invention extracted event-based DAS records based on the standard catalogs of the Northern California Seismic Network, Southern California Seismic Network, and Nevada Seismic Network. Following the semi-supervised learning approach outlined above, the pre-trained PHASENET model was applied to pick P and S arrivals in these extracted event data, the GaMMA model was applied to associate picks, and the events were kept with at least 500 P and S picks as the training datasets. In the first iteration using PHASENET as the pre-trained model, a dataset of 1056 events and 1116 events were obtained from the Mammoth north 806 and Mammoth south 808 cables, and 597 events and 1430 events were obtained from the Ridgecrest north 810 and Ridgecrest south 812 cables respectively.

In the second iteration using PHASENET-DAS v1 as the pre-trained model, a dataset of 3405 events and 3437 events were obtained from the Mammoth north 806 and Mammoth south 806 cables, and 3590 events and 3311 events were obtained from the Ridgecrest north 810 and Ridgecrest south 812 cables respectively. Because manual labels may not be available as ground truth to evaluate the model performance, each dataset may only be split into 90% training and 10% validation sets. Training samples of 3072×5120 (temporal samples×spatial channels) may be randomly selected, and a moving window normalization may be applied to each channel. The moving window normalization, implemented using a convolutional operation with a window size of 1024 and a stride step of 256, removes the mean and divides by the standard deviation within a fixed window size, making it independent of input data length. Coupled with the fully convolutional network architecture of PHASENET-DAS, the model can be applied to flexible length of continuous data. PHASENET-DAS may be trained using the ADAMW optimizer and a weight decay of 0.190, 91, an initial learning rate of 0.01, a cosine decay learning rate with linear warm-up 92, a batch size of 8, and 10 training epochs.

### Logical Flow

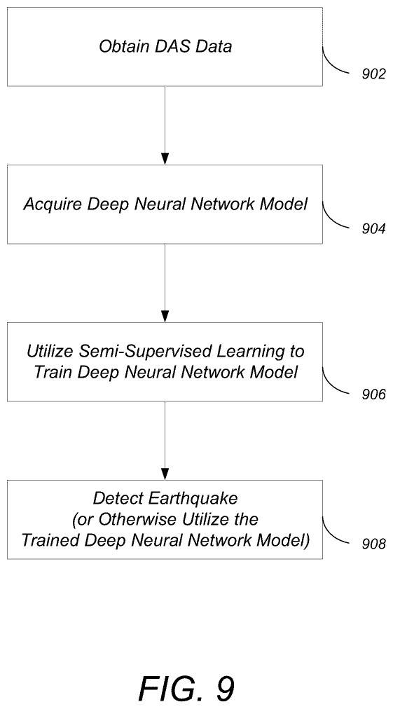

FIG. 9 illustrates the logical flow for detecting an earthquake in accordance with one or more embodiments of the invention.

At step 902, distributed acoustic sensing (DAS) data is obtained.

At step 904, a deep neural network model is acquired that picks seismic phase arrival times on the DAS data.

At step 906, a semi-supervised learning approach is utilized to train the deep neural network model. The semi-supervised learning approach utilizes existing labels from a defined seismic dataset to generate pseudo labels on the DAS data.

In one or more embodiments, the deep neural network model is trained by: (a) obtaining a two-dimensional (2D) DAS data as input; (2) extracting one or more features through a sequence of neural network layers of the deep neural network model; (3) mapping the one or more features to a 2D probability map of P-phase, S-phase, and noise; and (4) detecting and locating, based on the 2D probability map, P and S phase arrivals.

In one or more embodiments, the deep neural network model is trained by: (1) obtaining the defined seismic dataset; (2) training a second model based on the defined seismic dataset; and (3) utilizing the second model to generate pseudo labels on the DAS data. The utilization of the second model picks P and S arrivals on each channel of a DAS array independently to generate the pseudo labels of P and S picks. In such embodiments, a phase association method may be applied to filter out false picks and build the DAS data with the pseudo labels. Further, the phase association method may consist of/comprise a Gaussian Mixture Model Associator (GaMMA). In addition, the phase association method may only select picks that fall within a defined window of theoretical arrival times corresponding to associated earthquake locations.

Further to the above, in one or more embodiments, the second model may be trained by: multiple stages of downsampling and unsampling; a sequence of 2D convolutional layers and RELU activation functions; and predicting P and S phase arrivals in each channel of a DAS array. In such embodiments, the pseudo labels may utilize a Gaussian-shaped target function comprising:

$${P}_{P} = {e}^{- \frac{{( t - t P )}^{2}}{2 {σ}^{2}}}$$

$${P}_{P} = {e}^{- \frac{{( t - {t}_{S} )}^{2}}{2 {σ}^{2}}}$$

$${P}_{N} = max ( 0 , 1 - {P}_{P} - {P}_{S} )$$

wherein:
   t_{P} and t_{S} are arrival-times of P and S phase;
   P_{P}, P_{S}, and P_{N} are target functions for P-phase, S-phase, and Noise;
and
   σ is a width of the Gaussian-shaped target function.

In addition to the above, the DAS data may be augmented by: superposing noise onto seismic events; randomly flipping data along a spatial axis, masking part of the DAS data; superimposing double events; and stretching along a temporal axis and the spatial axes.

At step 908, one or more earthquakes are detected by applying the trained deep neural network model to new DAS data. Alternatively, the trained deep neural network model is otherwise utilized.

### Hardware Environment

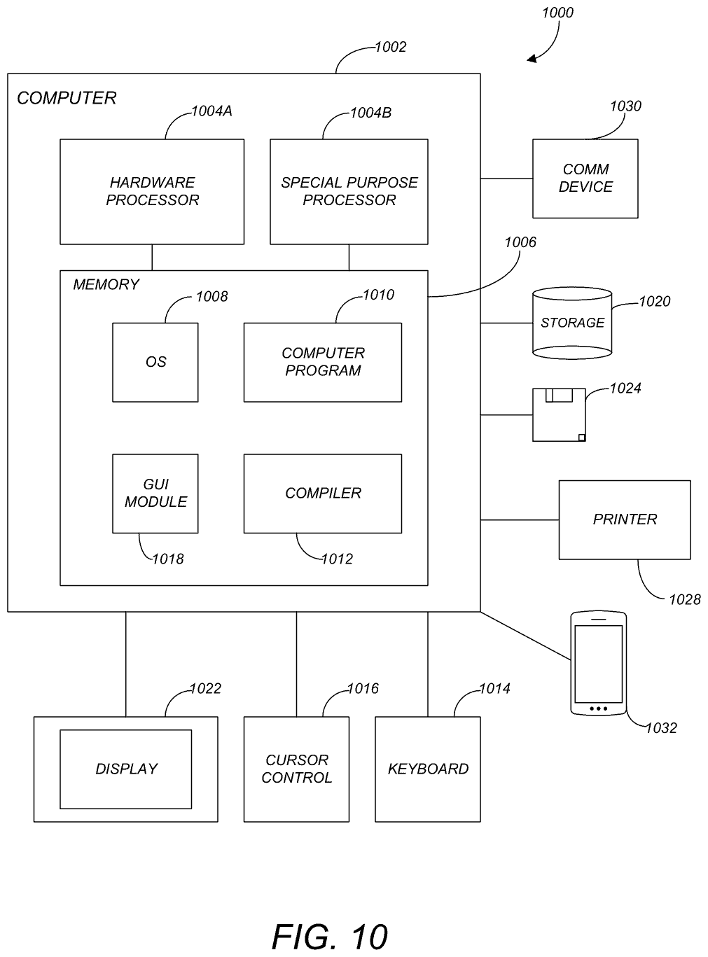

FIG. 10 is an exemplary hardware and software environment 1000 (referred to as a computer-implemented system and/or computer-implemented method) used to implement one or more embodiments of the invention. The hardware and software environment includes a computer 1002 and may include peripherals. Computer 1002 may be a user/client computer, server computer, or may be a database computer. The computer 1002 comprises a hardware processor 1004A and/or a special purpose hardware processor 1004B (hereinafter alternatively collectively referred to as processor 1004) and a memory 1006, such as random access memory (RAM). The computer 1002 may be coupled to, and/or integrated with, other devices, including input/output (I/O) devices such as a keyboard 1014, a cursor control device 1016 (e.g., a mouse, a pointing device, pen and tablet, touch screen, multi-touch device, etc.) and a printer 1028. In one or more embodiments, computer 1002 may be coupled to, or may comprise, a portable or media viewing/listening device 1032 (e.g., an MP3 player, IPOD, NOOK, portable digital video player, cellular device, personal digital assistant, etc.). In yet another embodiment, the computer 1002 may comprise a multi-touch device, mobile phone, gaming system, internet enabled television, television set top box, or other internet enabled device executing on various platforms and operating systems.

In one embodiment, the computer 1002 operates by the hardware processor 1004A performing instructions defined by the computer program 1010 (e.g., a computer-aided design [CAD] application) under control of an operating system 1008. The computer program 1010 and/or the operating system 1008 may be stored in the memory 1006 and may interface with the user and/or other devices to accept input and commands and, based on such input and commands and the instructions defined by the computer program 1010 and operating system 1008, to provide output and results.

Output/results may be presented on the display 1022 or provided to another device for presentation or further processing or action. In one embodiment, the display 1022 comprises a liquid crystal display (LCD) having a plurality of separately addressable liquid crystals. Alternatively, the display 1022 may comprise a light emitting diode (LED) display having clusters of red, green and blue diodes driven together to form full-color pixels. Each liquid crystal or pixel of the display 1022 changes to an opaque or translucent state to form a part of the image on the display in response to the data or information generated by the processor 1004 from the application of the instructions of the computer program 1010 and/or operating system 1008 to the input and commands. The image may be provided through a graphical user interface (GUI) module 1018. Although the GUI module 1018 is depicted as a separate module, the instructions performing the GUI functions can be resident or distributed in the operating system 1008, the computer program 1010, or implemented with special purpose memory and processors.

In one or more embodiments, the display 1022 is integrated with/into the computer 1002 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1002 according to the computer program 1010 instructions may be implemented in a special purpose processor 1004B. In this embodiment, some or all of the computer program 1010 instructions may be implemented via firmware instructions stored in a read only memory (ROM), a programmable read only memory (PROM) or flash memory within the special purpose processor 1004B or in memory 1006. The special purpose processor 1004B may also be hardwired through circuit design to perform some or all of the operations to implement the present invention. Further, the special purpose processor 1004B may be a hybrid processor, which includes dedicated circuitry for performing a subset of functions, and other circuits for performing more general functions such as responding to computer program 1010 instructions. In one embodiment, the special purpose processor 1004B is an application specific integrated circuit (ASIC).

The computer 1002 may also implement a compiler 1012 that allows an application or computer program 1010 written in a programming language such as C, C++, Assembly, SQL, PYTHON, PROLOG, MATLAB, RUBY, RAILS, HASKELL, or other language to be translated into processor 1004 readable code. Alternatively, the compiler 1012 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1010 accesses and manipulates data accepted from I/O devices and stored in the memory 1006 of the computer 1002 using the relationships and logic that were generated using the compiler 1012.

The computer 1002 also optionally comprises an external communication device such as a modem, satellite link, Ethernet card, or other device for accepting input from, and providing output to, other computers 1002.

In one embodiment, instructions implementing the operating system 1008, the computer program 1010, and the compiler 1012 are tangibly embodied in a non-transitory computer-readable medium, e.g., data storage device 1020, which could include one or more fixed or removable data storage devices, such as a zip drive, floppy disc drive 1024, hard drive, CD-ROM drive, tape drive, etc. Further, the operating system 1008 and the computer program 1010 are comprised of computer program 1010 instructions which, when accessed, read and executed by the computer 1002, cause the computer 1002 to perform the steps necessary to implement and/or use the present invention or to load the program of instructions into a memory 1006, thus creating a special purpose data structure causing the computer 1002 to operate as a specially programmed computer executing the method steps described herein. Computer program 1010 and/or operating instructions may also be tangibly embodied in memory 1006 and/or data communications devices 1030, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1002.

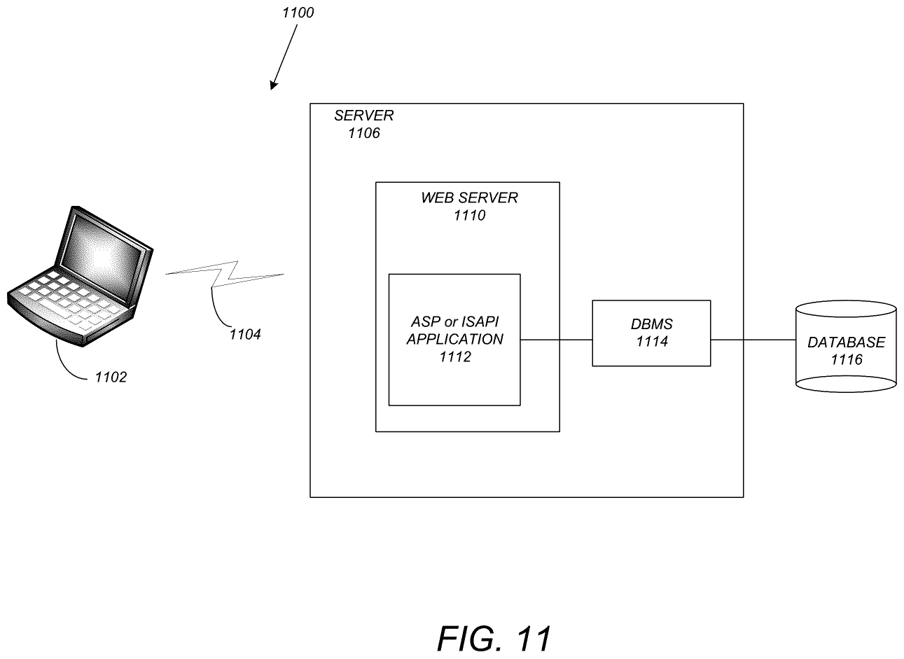

FIG. 11 schematically illustrates a typical distributed/cloud-based computer system 1100 using a network 1104 to connect client computers 1102 to server computers 1106. A typical combination of resources may include a network 1104 comprising the Internet, LANs (local area networks), WANs (wide area networks), SNA (systems network architecture) networks, or the like, clients 1102 that are personal computers or workstations (as set forth in FIG. 10), and servers 1106 that are personal computers, workstations, minicomputers, or mainframes (as set forth in FIG. 10). However, it may be noted that different networks such as a cellular network (e.g., GSM [global system for mobile communications] or otherwise), a satellite based network, or any other type of network may be used to connect clients 1102 and servers 1106 in accordance with embodiments of the invention.

A network 1104 such as the Internet connects clients 1102 to server computers 1106. Network 1104 may utilize ethernet, coaxial cable, wireless communications, radio frequency (RF), etc. to connect and provide the communication between clients 1102 and servers 1106. Further, in a cloud-based computing system, resources (e.g., storage, processors, applications, memory, infrastructure, etc.) in clients 1102 and server computers 1106 may be shared by clients 1102, server computers 1106, and users across one or more networks. Resources may be shared by multiple users and can be dynamically reallocated per demand. In this regard, cloud computing may be referred to as a model for enabling access to a shared pool of configurable computing resources.

Clients 1102 may execute a client application or web browser and communicate with server computers 1106 executing web servers 1110. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1102 may be downloaded from server computer 1106 to client computers 1102 and installed as a plug-in or ACTIVEX control of a web browser. Accordingly, clients 1102 may utilize ACTIVEX components/component object model (COM) or distributed COM (DCOM) components to provide a user interface on a display of client 1102. The web server 1110 is typically a program such as MICROSOFT'S INTERNET INFORMATION SERVER.

Web server 1110 may host an Active Server Page (ASP) or Internet Server Application Programming Interface (ISAPI) application 1112, which may be executing scripts. The scripts invoke objects that execute business logic (referred to as business objects). The business objects then manipulate data in database 1116 through a database management system (DBMS) 1114. Alternatively, database 1116 may be part of, or connected directly to, client 1102 instead of communicating/obtaining the information from database 1116 across network 1104. When a developer encapsulates the business functionality into objects, the system may be referred to as a component object model (COM) system. Accordingly, the scripts executing on web server 1110 (and/or application 1112) invoke COM objects that implement the business logic. Further, server 1106 may utilize MICROSOFT'S TRANSACTION SERVER (MTS) to access required data stored in database 1116 via an interface such as ADO (Active Data Objects), OLE DB (Object Linking and Embedding DataBase), or ODBC (Open DataBase Connectivity).

Generally, these components 1100-1116 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1102 and 1106 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1102 and 1106. Embodiments of the invention are implemented as a software/CAD application on a client 1102 or server computer 1106. Further, as described above, the client 1102 or server computer 1106 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[1] Zhongwen Zhan. Distributed acoustic sensing turns fiber-optic cables into sensitive seismic antennas. Seismological Research Letters, 91(1):1-15, 2020.
[2] Nathaniel J. Lindsey and Eileen R. Martin. Fiber-Optic Seismology. Annual Review of Earth and Planetary Sciences, 49(1):309-336, May 2021. ISSN 0084-6597, 1545-4495.
[3] Eileen R. Martin, Nathaniel J. Lindsey, Jonathan B. Ajo-Franklin, and Biondo L. Biondi. Introduction to Interferometry of Fiber-Optic Strain Measurements. In Distributed Acoustic Sensing in Geophysics, chapter 9, pages 111-129. American Geophysical Union (AGU), 2021. ISBN 978-1-119-52180-8.
[4] Nathaniel J. Lindsey, Eileen R. Martin, Douglas S. Dreger, Barry Freifeld, Stephen Cole, Stephanie R. James, Biondo L. Biondi, and Jonathan B. Ajo-Franklin. Fiber-Optic Network Observations of Earth-quake Wavefields. Geophysical Research Letters, 44(23): 11,792-11,799, 2017. ISSN 1944-8007.
[5] Ethan F. Williams, Mar\acute{ }ιa R. Fernandez-Ruiz, Regina Magalhaes, Roel Vanthillo, Zhongwen Zhan, Miguel Gonz\acute{ }alez-Herr\acute{ }aez, and Hugo F. Martins. Distributed sensing of microseisms and teleseisms with submarine dark fibers. Nature Communications, 10(1):5778, December 2019. ISSN 2041-1723.
[6] Nathaniel J. Lindsey, Horst Rademacher, and Jonathan B. Ajo-Franklin. On the broadband instrument response of fiber-optic DAS arrays. Journal of Geophysical Research: Solid Earth, 125(2): e2019JB018145, 2020.
[7] Zefeng Li and Zhongwen Zhan. Pushing the limit of earthquake detection with distributed acoustic sensing and template matching: A case study at the Brady geothermal field. Geophysical Journal International, 215(3):1583-1593, 2018.
[8] Zefeng Li, Zhichao Shen, Yan Yang, Ethan Williams, Xin Wang, and Zhongwen Zhan. Rapid response to the 2019 Ridgecrest earthquake with distributed acoustic sensing. AGU Advances, 2(2):e2021AV000395, 2021.
[9] Jiaxuan Li, Taeho Kim, Nadia Lapusta, Ettore Biondi, and Zhongwen Zhan. The break of earthquake asperities imaged by distributed acoustic sensing. Nature, pages 1-7, August 2023. ISSN 1476-4687.
[10] Rex V. Allen. Automatic earthquake recognition and timing from single traces. Bulletin of the Seismological Society of America, 68(5):1521-1532, October 1978. ISSN 0037-1106.
[11] Steven J. Gibbons and Frode Ringdal. The detection of low magnitude seismic events using array-based waveform correlation. Geophysical Journal International, 165(1):149-166, 2006.
[12] Zhigang Peng and Peng Zhao. Migration of early aftershocks following the 2004 Parkfield earthquake. Nature Geoscience, 2(12):877-881, 2009.
[13] David R. Shelly, Gregory C. Beroza, and Satoshi Ide. Non-volcanic tremor and low-frequency earthquake swarms. Nature, 446(7133):305-307, 2007.
[14] Zachary E. Ross, Daniel T. Trugman, Egill Hauksson, and Peter M. Shearer. Searching for hidden earthquakes in Southern California. Science, 364(6442):767-771, 2019.
[15] Zefeng Li and Zhongwen Zhan. Pushing the limit of earthquake detection with distributed acoustic sensing and template matching: A case study at the brady geothermal field. Geophysical Journal International, 215(3):1583-1593, 2018.
[16] Zefeng Li, Zhichao Shen, Yan Yang, Ethan Williams, Xin Wang, and Zhongwen Zhan. Rapid response to the 2019 Ridgecrest earthquake with distributed acoustic sensing. AGU Advances, 2(2):e2021AV000395, 2021.
[17] Yann LeCun, Yoshua Bengio, and Geoffrey Hinton. Deep learning. Nature, 521(7553):436-444, May 2015. ISSN 1476-4687.
[18] Thibaut Perol, Micha\ddot{ }el Gharbi, and Marine Denolle. Convolutional neural network for earthquake detection and location. Science Advances, 4(2):e 1700578, February 2018.
[19] Zachary E. Ross, Men-Andrin Meier, Egill Hauksson, and Thomas H. Heaton. Generalized Seismic Phase Detection with Deep Learning. Bulletin of the Seismological Society of America, 108(5A):2894-2901, August 2018. ISSN 0037-1106.
[20] Weiqiang Zhu and Gregory C. Beroza. PHASENET: A deep-neural-network-based seismic arrival-time picking method. Geophysical Journal International, 216(1):261-273, 2019.
[21] S. Mostafa Mousavi, William L. Ellsworth, Weiqiang Zhu, Lindsay Y. Chuang, and Gregory C. Beroza. Earthquake transformer—an attentive deep-learning model for simultaneous earthquake detection and phase picking. Nature Communications, 11(1):3952, August 2020. ISSN 2041-1723.
[22] Weiqiang Zhu, Kai Sheng Tai, S. Mostafa Mousavi, Peter Bailis, and Gregory C. Beroza. An End-To-End Earthquake Detection Method for Joint Phase Picking and Association Using Deep Learning. Journal of Geophysical Research: Solid Earth, 127(3):e2021JB023283, 2022. ISSN 2169-9356.
[23] S. Mostafa Mousavi and Gregory C. Beroza. Deep-learning seismology. Science, 377(6607):eabm4470, August 2022.
[24] Yongsoo Park, S. Mostafa Mousavi, Weiqiang Zhu, William L. Ellsworth, and Gregory C. Beroza. Machine-Learning-Based Analysis of the Guy-Greenbrier, Arkansas Earthquakes: A Tale of Two Sequences. Geophysical Research Letters, 47(6):e2020GL087032, 2020. ISSN 1944-8007.
[25] Min Liu, Miao Zhang, Weiqiang Zhu, William L. Ellsworth, and Hongyi Li. Rapid Characterization of the July 2019 Ridgecrest, California, Earthquake Sequence From Raw Seismic Data Using Machine-Learning Phase Picker. Geophysical Research Letters, 47(4):e2019GL086189, 2020. ISSN 1944-8007.
[26] Yen Joe Tan, Felix Waldhauser, William L. Ellsworth, Miao Zhang, Weiqiang Zhu, Maddalena Michele, Lauro Chiaraluce, Gregory C. Beroza, and Margarita Segou. Machine-Learning-Based High-Resolution Earthquake Catalog Reveals How Complex Fault Structures Were Activated during the 2016-2017 Central Italy Sequence. The Seismic Record, 1(1): 11-19, May 2021. ISSN 2694-4006.
[27] Yongsoo Park, Gregory C. Beroza, and William L. Ellsworth. A Deep Earthquake Catalog for Oklahoma and Southern Kansas Reveals Extensive Basement Fault Networks. Preprint, Geophysics, October 2021.
[28] JinBo S U, Min L I U, YunPeng ZHANG, WeiTao WANG, Hong Yi L I, Jun YANG, XiaoBin L I, and Miao ZHANG. High resolution earthquake catalog building for the 21 May 2021 Yangbi, Yunnan, M S 6.4 earthquake sequence using deep-learning phase picker. Chinese Journal of Geophysics, 64(8):2647-2656, 2021. ISSN 0001-5733.
[29] John D. Wilding, Weiqiang Zhu, Zachary E. Ross, and Jennifer M. Jackson. The magmatic web beneath Hawaii. Science, 0(0):eade5755, December 2022.
[30] Xin Huang, Jangsoo Lee, Young-Woo Kwon, and Chul-Ho Lee. CrowdQuake: A Networked System of Low-Cost Sensors for Earthquake Detection via Deep Learning. In Proceedings of the 26th ACM SIGKDD International Conference on Knowledge Discovery & Data Mining, KDD '20, pages 3261-3271, New York, NY, USA, August 2020. Association for Computing Machinery. ISBN 978-1-4503-7998-4.
[31] William Luther Yeck, John M. Patton, Zachary E. Ross, Gavin P. Hayes, Michelle R. Guy, Nick B. Ambruz, David R. Shelly, Harley M. Benz, and Paul S. Earle. Leveraging Deep Learning in Global 24/7 Real-Time Earthquake Monitoring at the National Earthquake Information Center. Seismological Research Letters, 92(1):469-480, September 2020. ISSN 0895-0695.
[32] Miao Zhang, Min Liu, Tian Feng, Ruijia Wang, and Weiqiang Zhu. LOC-FLOW: An End-to-End Machine Learning-Based High-Precision Earthquake Location Workflow. Seismological Research Letters, 93(5):2426-2438, March 2022. ISSN 0895-0695.
[33] Lise Retailleau, Jean-Marie Saurel, Weiqiang Zhu, Claudio Satriano, Gregory C. Beroza, Simon Issartel, Patrice Boissier, OVPF Team, and OVSM Team. A Wrapper to Use a Machine-Learning-Based Algorithm for Earthquake Monitoring. Seismological Research Letters, 93(3):1673-1682, February 2022. ISSN 0895-0695.
[34] Peidong Shi, Francesco Grigoli, Federica Lanza, Gregory C. Beroza, Luca Scarabello, and Stefan Wiemer. MALMI: An Automated Earthquake Detection and Location Workflow Based on Machine Learning and Waveform Migration. Seismological Research Letters, 93(5):2467-2483, May 2022. ISSN 0895-0695.
[35] Lise Retailleau, Jean-Marie Saurel, Marine Laporte, Aude Lavayssi\grave{ }ere, Val\acute{ }erie Ferrazzini, Weiqiang Zhu, Gregory C. Beroza, Claudio Satriano, Jean-Christophe Komorowski, and Ovpf Team. Automatic detection for a comprehensive view of Mayotte seismicity. Comptes Rendus. Geoscience, 354(S2):1-18, 2022. ISSN 1778-7025.
[36] John D. Wilding, Weiqiang Zhu, Zachary E. Ross, and Jennifer M. Jackson. The magmatic web beneath Hawaii. Science, page eade5755, 2022.
[37] Alberto Michelini, Spina Cianetti, Sonja Gaviano, Carlo Giunchi, Dario Jozinovic, and Valentino Lauciani. INSTANCE—the Italian seismic dataset for machine learning. Earth System Science Data, 13 (12):5509-5544, November 2021. ISSN 1866-3508.
[38] Ming Zhao, Zhuowei Xiao, Shi Chen, and L. H. Fang. DiTing: A large-scale Chinese seismic benchmark dataset for artificial intelligence in seismology. Earthquake Science, 35:1-11, 2022.
[39] S. Mostafa Mousavi, Yixiao Sheng, Weiqiang Zhu, and Gregory C. Beroza. Stanford Earthquake Dataset (STEAD): A global data set of seismic signals for AI. IEEE Access, 7:179464-179476, 2019.
[40] Jack Woollam, Andreas Rietbrock, Angel Bueno, and Silvio De Angelis. Convolutional Neural Network for Seismic Phase Classification, Performance Demonstration over a Local Seismic Network. Seismological Research Letters, 90(2A):491-502, January 2019. ISSN 0895-0695.
[41] William Luther Yeck, John M. Patton, Zachary E. Ross, Gavin P. Hayes, Michelle R. Guy, Nick B. Ambruz, David R. Shelly, Harley M. Benz, and Paul S. Earle. Leveraging Deep Learning in Global 24/7 Real-Time Earthquake Monitoring at the National Earthquake Information Center. Seismological Research Letters, 92(1):469-480, September 2020. ISSN 0895-0695.
[42] Jack Woollam, Jannes Mu\ddot{ }nchmeyer, Frederik Tilmann, Andreas Rietbrock, Dietrich Lange, Thomas Bornstein, Tobias Diehl, Carlo Giunchi, Florian Haslinger, Dario Jozinovic, Alberto Michelini, Joachim Saul, and Hugo Soto. SeisBench—A Toolbox for Machine Learning in Seismology. Seismological Research Letters, 93(3): 1695-1709, March 2022. ISSN 0895-0695.
[43] Zack J. Spica, Jonathan Ajo-Franklin, Greg Beroza, Biondo Biondi, Feng Cheng, Beatriz Gaite, Bin Luo, Eileen Martin, Junzhu Shen, Clifford Thurber, Lo\ddot{ }ic Viens, Herbert Wang, Andreas Wuestefeld, Han Xiao, and Tieyuan Zhu. PubDAS: A Public Distributed Acoustic Sensing datasets repository for geosciences. September 2022.
[44] Pablo D. Hern\acute{ }andez, Jaime A. Ramirez, and Marcelo A. Soto. Improving Earthquake Detection in Fibre-Optic Distributed Acoustic Sensors Using Deep-Learning and Hybrid Datasets. In 2022 European Conference on Optical Communication (ECOC), pages 1-4, September 2022.
[45] Hao Lv, Xiangfang Zeng, Feng Bao, Jun Xie, Rongbing Lin, Zhenghong Song, and Gongbo Zhang. ADE-Net: A Deep Neural Network for DAS Earthquake Detection Trained With a Limited Number of Positive Samples. IEEE Transactions on Geoscience and Remote Sensing, 60:1-11, 2022. ISSN 1558-0644.
[46] Fantine Huot, Robert G. Clapp, and Biondo L. Biondi. Detecting local earthquakes via fiber-optic cables in telecommunication conduits under Stanford University campus using deep learning, March 2022.
[47] Weiqiang Zhu, S. Mostafa Mousavi, and Gregory C. Beroza. Chapter Four—Seismic signal augmentation to improve generalization of deep neural networks. In Ben Moseley and Lion Krischer, editors, Advances in Geophysics, volume 61 of Machine Learning in Geosciences, pages 151-177. Elsevier, January 2020.
[48] Wenhuan Kuang, Congcong Yuan, and Jie Zhang. Real-time determination of earthquake focal mechanism via deep learning. Nature Communications, 12(1):1432, March 2021. ISSN 2041-1723.
[49] Jonathan D. Smith, Kamyar Azizzadenesheli, and Zachary E. Ross. EikoNet: Solving the Eikonal Equation With Deep Neural Networks. IEEE Transactions on Geoscience and Remote Sensing, 59(12): 10685-10696, December 2021. ISSN 1558-0644.
[50] Nikolaj L. Dahmen, John F. Clinton, Men-Andrin Meier, Simon C. Stahler, Savas Ceylan, Doyeon Kim, Alexander E. Stott, and Domenico Giardini. MarsQuakeNet: A More Complete Marsquake Catalog Obtained by Deep Learning Techniques. Journal of Geophysical Research: Planets, 127(11): e2022JE007503, 2022. ISSN 2169-9100.
[51] Chengping Chai, Monica Maceira, Hector J. Santos-Villalobos, Singanallur V. Venkatakrishnan, Martin Schoenball, Weiqiang Zhu, Gregory C. Beroza, Clifford Thurber, and EGS Collab Team. Using a Deep Neural Network and Transfer Learning to Bridge Scales for Seismic Phase Picking. Geophysical Research Letters, 47(16):e2020GL088651, 2020. ISSN 1944-8007.
[52] Dario Jozinovic, Anthony Lomax, Ivan Stajduhar, and Alberto Michelini. Transfer learning: Improving neural network based prediction of earthquake ground shaking for an area with insufficient training data. Geophysical Journal International, 229(1):704-718, April 2022. ISSN 0956-540X.
[53] Martijn van den Ende, Itzhak Lior, Jean-Paul Ampuero, Anthony Sladen, Andre Ferrari, and Cedric Richard. A Self-Supervised Deep Learning Approach for Blind Denoising and Waveform Coherence Enhancement in Distributed Acoustic Sensing Data. IEEE Transactions on Neural Networks and Learning Systems, pages 1-14, 2021. ISSN 2162-2388.
[54] S. Mostafa Mousavi, Weiqiang Zhu, William Ellsworth, and Gregory Beroza. Unsupervised Clustering of Seismic Signals Using Deep Convolutional Autoencoders. IEEE Geoscience and Remote Sensing Letters, 16(11):1693-1697, November 2019. ISSN 1558-0571.
[55] L\acute{ }eonard Seydoux, Randall Balestriero, Piero Poli, Maarten de Hoop, Michel Campillo, and Richard Baraniuk. Clustering earthquake signals and background noises in continuous seismic data with unsupervised deep learning. Nature Communications, 11(1):3972, August 2020. ISSN 2041-1723.
[56] Qizhe Xie, Minh-Thang Luong, Eduard Hovy, and Quoc V. Le. Self-Training With Noisy Student Improves ImageNet Classification. In 2020 IEEE/CVF Conference on Computer Vision and Pattern Recognition (CVPR), pages 10684-10695, Seattle, WA, USA, June 2020. IEEE. ISBN 978-1-72817-168-5.
[57] Xiaojin (Jerry) Zhu. Semi-Supervised Learning Literature Survey. Technical Report, University of Wisconsin-Madison Department of Computer Sciences, 2005.
[58] Eric Arazo, Diego Ortego, Paul Albert, Noel E. O'Connor, and Kevin McGuinness. Pseudo-Labeling and Confirmation Bias in Deep Semi-Supervised Learning. In 2020 International Joint Conference on Neural Networks (IJCNN), pages 1-8, July 2020.
[59] Weiqiang Zhu, Ian W. McBrearty, S. Mostafa Mousavi, William L. Ellsworth, and Gregory C. Beroza. Earthquake phase association using a Bayesian Gaussian mixture model. Journal of Geophysical Re-search: Solid Earth, 127(5):e2021JB023249, 2022.
[60] David Hadley and Hiroo Kanamori. Seismic structure of the transverse ranges, California. Geological Society of America Bulletin, 88(10):1469-1478, 1977.
[61] Felix Waldhauser and William L. Ellsworth. A Double-Difference Earthquake Location Algorithm: Method and Application to the Northern Hayward Fault, California. Bulletin of the Seismological Society of America, 90(6):1353-1368, December 2000. ISSN 0037-1106.
[62] Haijiang Zhang and Clifford H. Thurber. Double-Difference Tomography: The Method and Its Ap-plication to the Hayward Fault, California. Bulletin of the Seismological Society of America, 93(5): 1875-1889, October 2003. ISSN 0037-1106.
[63] Miao Zhang and Lianxing Wen. An effective method for small event detection: Match and locate (M&L). Geophysical Journal International, 200(3):1523-1537, March 2015. ISSN 0956-540X.
[64] Daniel T. Trugman and Peter M. Shearer. GrowClust: A Hierarchical Clustering Algorithm for Relative Earthquake Relocation, with Application to the Spanish Springs and Sheldon, Nevada, Earthquake Sequences. Seismological Research Letters, 88(2A):379-391, February 2017. ISSN 0895-0695.
[65] David R. Shelly, Jeanne L. Hardebeck, William L. Ellsworth, and David P. Hill. A new strategy for earthquake focal mechanisms using waveform-correlation-derived relative polarities and cluster analysis: Application to the 2014 Long Valley Caldera earthquake swarm. Journal of Geophysical Research: Solid Earth, 121(12):8622-8641, 2016. ISSN 2169-9356.
[66] David R. Shelly, Robert J. Skoumal, and Jeanne L. Hardebeck. Fracture-mesh faulting in the swarm-like 2020 Maacama sequence revealed by high-precision earthquake detection, location, and focal mechanisms. Geophysical Research Letters, n/a(n/a):e2022GL101233. ISSN 1944-8007.
[67] J. C. VanDecar and R. S. Crosson. Determination of teleseismic relative phase arrival times using multi-channel cross-correlation and least squares. Bulletin of the Seismological Society of America, 80 (1):150-169, February 1990. ISSN 0037-1106.
[68] Jiaxuan Li, Weiqiang Zhu, Ettore Biondi, and Zhongwen Zhan. Earthquake focal mechanisms with distributed acoustic sensing. Nature Communications, 14(1):4181, 2023.
[69] Weiqiang Zhu, Alvin Brian Hou, Robert Yang, Avoy Datta, S Mostafa Mousavi, William L Ellsworth, and Gregory C Beroza. QuakeFlow: A scalable machine-learning-based earthquake monitoring workflow with cloud computing. Geophysical Journal International, 232(1):684-693, January 2023. ISSN 0956-540X.
[70] Jiuxun Yin, Weiqiang Zhu, Jiaxuan Li, Ettore Biondi, Yaolin Miao, Zack J Spica, Loιc Viens, Masanao Shinohara, Satoshi Ide, Kimihiro Mochizuki, et al. Earthquake magnitude with das: A transferable data-based scaling relation. Geophysical Research Letters, 50(10):e2023GL103045, 2023.
[71] David R. Shelly, Gregory C. Beroza, and Satoshi Ide. Non-volcanic tremor and low-frequency earthquake swarms. Nature, 446(7133):305-307, March 2007. ISSN 1476-4687.
[72] Gregory C. Beroza and Satoshi Ide. Slow Earthquakes and Nonvolcanic Tremor. Annual Review of Earth and Planetary Sciences, 39(1):271-296, May 2011. ISSN 0084-6597, 1545-4495.
[73] Zachary E Ross, Men-Andrin Meier, and Egill Hauksson. P wave arrival picking and first-motion polarity determination with deep learning. Journal of Geophysical Research: Solid Earth, 123(6):5120-5129, 2018.
[74] Weiqiang Zhu, S. Mostafa Mousavi, and Gregory C. Beroza. Seismic signal augmentation to improve generalization of deep neural networks. In Advances in Geophysics, volume 61, pages 151-177. Elsevier, 2020.
[75] Christian Szegedy, Vincent Vanhoucke, Sergey Ioffe, Jon Shlens, and Zbigniew Wojna. Rethinking the inception architecture for computer vision. In Proceedings of the IEEE conference on computer vision and pattern recognition, pages 2818-2826, 2016.
[76] Connor Shorten and Taghi M. Khoshgoftaar. A survey on Image Data Augmentation for Deep Learning. Journal of Big Data, 6(1):60, July 2019. ISSN 2196-1115.
[77] Olaf Ronneberger, Philipp Fischer, and Thomas Brox. U-Net: Convolutional Networks for Biomedical Image Segmentation, May 2015.
[78] Wenjie Luo, Yujia Li, Raquel Urtasun, and Richard Zemel. Understanding the Effective Receptive Field in Deep Convolutional Neural Networks. In Advances in Neural Information Processing Systems, volume 29. Curran Associates, Inc., 2016.
[79] Hyeonwoo Noh, Seunghoon Hong, and Bohyung Han. Learning Deconvolution Network for Semantic Segmentation. In 2015 IEEE International Conference on Computer Vision (ICCV), pages 1520-1528, Santiago, Chile, December 2015. IEEE. ISBN 978-1-4673-8391-2.
[80] Sergey Ioffe and Christian Szegedy. Batch Normalization: Accelerating Deep Network Training by Reducing Internal Covariate Shift. In Proceedings of the 32nd International Conference on Machine Learning, pages 448-456. PMLR, June 2015.
[81] Xavier Glorot, Antoine Bordes, and Yoshua Bengio. Deep Sparse Rectifier Neural Networks. In Proceedings of the Fourteenth International Conference on Artificial Intelligence and Statistics, pages 315-323. JMLR Workshop and Conference Proceedings, June 2011.
[82] Liang-Chieh Chen, George Papandreou, Florian Schroff, and Hartwig Adam. Rethinking Atrous Convolution for Semantic Image Segmentation, December 2017.
[83] Jifeng Dai, Haozhi Qi, Yuwen Xiong, Yi Li, Guodong Zhang, Han Hu, and Yichen Wei. Deformable Convolutional Networks, June 2017.
[84] Ze Liu, Yutong Lin, Yue Cao, Han Hu, Yixuan Wei, Zheng Zhang, Stephen Lin, and Baining Guo. Swin Transformer: Hierarchical Vision Transformer Using Shifted Windows. In Proceedings of the IEEE/CVF International Conference on Computer Vision, pages 10012-10022, 2021.
[85] Ashish Vaswani, Noam Shazeer, Niki Parmar, Jakob Uszkoreit, Llion Jones, Aidan N Gomez, Lukasz Kaiser, and Illia Polosukhin. Attention is All you Need. In Advances in Neural Information Processing Systems, volume 30. Curran Associates, Inc., 2017.
[86] Yan Yang, James W. Atterholt, Zhichao Shen, Jack B. Muir, Ethan F. Williams, and Zhongwen Zhan. Sub-Kilometer Correlation Between Near-Surface Structure and Ground Motion Measured With Dis-tributed Acoustic Sensing. Geophysical Research Letters, 49(1):e2021GL096503, 2022. ISSN 1944-8007.
[87] Yan Yang, Zhongwen Zhan, Zhichao Shen, and James Atterholt. Fault Zone Imaging With Distributed Acoustic Sensing: Surface-To-Surface Wave Scattering. Journal of Geophysical Research: Solid Earth, 127(6):e2022JB024329, 2022. ISSN 2169-9356.
[88] James Atterholt, Zhongwen Zhan, and Yan Yang. Fault Zone Imaging With Distributed Acoustic Sensing: Body-To-Surface Wave Scattering. Journal of Geophysical Research: Solid Earth, 127(11): e2022JB025052, 2022. ISSN 2169-9356.
[89] Ettore Biondi, Xin Wang, Ethan F Williams, and Zhongwen Zhan. Geolocalization of large-scale das channels using a GPS-tracked moving vehicle. Seismological Society of America, 94(1):318-330, 2023.
[90] Diederik P Kingma and Jimmy Ba. Adam: A method for stochastic optimization. arXiv preprint arXiv:1412.6980, 2014.
[91] Ilya Loshchilov and Frank Hutter. Decoupled Weight Decay Regularization. November 2017.
[92] Tong He, Zhi Zhang, Hang Zhang, Zhongyue Zhang, Junyuan Xie, and Mu Li. Bag of Tricks for Image Classification with Convolutional Neural Networks. In 2019 IEEE/CVF Conference on Computer Vision and Pattern Recognition (CVPR), pages 558-567, Long Beach, CA, USA, June 2019. IEEE. ISBN 978-1-72813-293-8.

What is claimed is:

1. A computer-implemented method for detecting an earthquake, comprising:
(a) obtaining distributed acoustic sensing (DAS) data;
(b) acquiring a deep neural network model that picks seismic phase arrival times on the DAS data;
(c) utilizing a semi-supervised learning approach to train the deep neural network model, wherein the semi-supervised learning approach:
(1) utilizes existing labels from a defined seismic dataset to generate pseudo labels on the DAS data; and
(d) detecting an earthquake by applying the trained deep neural network model to new DAS data.

2. The computer-implemented method of claim 1, wherein the deep neural network model is trained by:
obtaining a two-dimensional (2D) DAS data as input;
extracting one or more features through a sequence of neural network layers of the deep neural network model;
mapping the one or more features to a 2D probability map of P-phase, S-phase, and noise; and
detecting and locating, based on the 2D probability map, P and S phase arrivals.

3. The computer-implemented method of claim 2, wherein the neural network model comprises:
multiple stages of downsampling and unsampling;
a sequence of 2D convolutional layers and RELU activation functions; and
predicting P and S phase arrivals in each channel of a DAS array.

4. The computer-implemented method of claim 3, wherein:
the pseudo labels utilize a Gaussian-shaped target function comprising:
$${P}_{P} = {e}^{- \frac{{( t - t P )}^{2}}{2 {σ}^{2}}}$$
$${P}_{P} = {e}^{- \frac{{( t - {t}_{S} )}^{2}}{2 {σ}^{2}}}$$
$${P}_{N} = max ( 0 , 1 - {P}_{P} - {P}_{S} )$$
wherein:
t_{P} and t_{S} are arrival-times of P and S phase;
P_{P}, P_{S}, and P_{N} are target functions for P-phase, S-phase, and Noise; and
σ is a width of the Gaussian-shaped target function.

5. The computer-implemented method of claim 4, further comprising augmenting the DAS data by:
superposing noise onto seismic events;
randomly flipping data along a spatial axis, masking part of the DAS data;
superimposing double events; and
stretching along a temporal axis and the spatial axes.

6. The computer-implemented method of claim 1, wherein the deep neural network model is trained by:
obtaining the defined seismic dataset;
training a second model based on the defined seismic dataset;
utilizing the second model to generate pseudo labels on the DAS data, wherein the utilizing picks P and S arrivals on each channel of a DAS array independently to generate the pseudo labels of P and S picks.

7. The computer-implemented method of claim 6, further comprising:
applying a phase association method to filter out false picks and build the DAS data with the pseudo labels.

8. The computer-implemented method of claim 7, wherein the phase association method comprises a Gaussian Mixture Model Associator (GaMMA).

9. The computer-implemented method of claim 7, wherein the phase association method selects only picks that fall within a defined window of theoretical arrival times corresponding to associated earthquake locations.

10. A computer-implemented system for detecting an earthquake, comprising:
(a) a computer having a memory;
(b) a processor executing on the computer;
(c) the memory storing a set of instructions, wherein the set of instructions, when executed by the processor cause the processor to perform operations comprising:
(1) obtaining distributed acoustic sensing (DAS) data;
(2) acquiring a deep neural network model that picks seismic phase arrival times on the DAS data;
(3) utilizing a semi-supervised learning approach to train the deep neural network model, wherein the semi-supervised learning approach:
(i) utilizes existing labels from a defined seismic dataset to generate pseudo labels on the DAS data; and
(4) detecting an earthquake by applying the trained deep neural network model to new DAS data.

11. The computer-implemented system of claim 10, wherein the deep neural network model is trained by:
obtaining a two-dimensional (2D) DAS data as input;
extracting one or more features through a sequence of neural network layers of the deep neural network model;
mapping the one or more features to a 2D probability map of P-phase, S-phase, and noise; and
detecting and locating, based on the 2D probability map, P and S phase arrivals.

12. The computer-implemented system of claim 11, wherein the neural network model comprises:
multiple stages of downsampling and unsampling;
a sequence of 2D convolutional layers and RELU activation functions; and
predicting P and S phase arrivals in each channel of a DAS array.

13. The computer-implemented system of claim 12, wherein:
the pseudo labels utilize a Gaussian-shaped target function comprising:
$${P}_{P} = {e}^{- \frac{{( t - t P )}^{2}}{2 {σ}^{2}}}$$
$${P}_{P} = {e}^{- \frac{{( t - {t}_{S} )}^{2}}{2 {σ}^{2}}}$$
$${P}_{N} = max ( 0 , 1 - {P}_{P} - {P}_{S} )$$
wherein:
t_{P} and t_{S} are arrival-times of P and S phase;
P_{P}, P_{S}, and P_{N} are target functions for P-phase, S-phase, and Noise; and
σ is a width of the Gaussian-shaped target function.

14. The computer-implemented system of claim 13, the operations further comprising augmenting the DAS data by:
superposing noise onto seismic events;
randomly flipping data along a spatial axis, masking part of the DAS data;
superimposing double events; and
stretching along a temporal axis and the spatial axes.

15. The computer-implemented system of claim 10, wherein the deep neural network model is trained by:
obtaining the defined seismic dataset;
training a second model based on the defined seismic dataset;
utilizing the second model to generate pseudo labels on the DAS data, wherein the utilizing picks P and S arrivals on each channel of a DAS array independently to generate the pseudo labels of P and S picks.

16. The computer-implemented system of claim 15, the operations further comprising:
applying a phase association method to filter out false picks and build the DAS data with the pseudo labels.

17. The computer-implemented system of claim 16, wherein the phase association method comprises a Gaussian Mixture Model Associator (GaMMA).

18. The computer-implemented system of claim 16, wherein the phase association method selects only picks that fall within a defined window of theoretical arrival times corresponding to associated earthquake locations.
